(19) United States
(12) Patent Application Publication
(10) Pub. No.: US 2021/0326786 A1
(43) Pub. Date: Oct. 21, 2021

(54) BLOCKCHAIN-BASED SERVICE PROCESSING METHODS AND APPARATUSES

(71) Applicant: ALIPAY (HANGZHOU) INFORMATION TECHNOLOGY CO., LTD., Hangzhou (CN)

(72) Inventors: Shanlu Sun, Hangzhou (CN); Ping Dai, Hangzhou (CN); Diaolong Tang, Hangzhou (CN); Xiao Wu, Hangzhou (CN)

(73) Assignee: ALIPAY (HANGZHOU) INFORMATION TECHNOLOGY CO., LTD., Hangzhou (CN)

(21) Appl. No.: 17/361,013

(22) Filed: Jun. 28, 2021

(30) Foreign Application Priority Data
Sep. 21, 2020 (CN) 202010997262.5

(51) Int. Cl. G06Q 10/06; H04L 9/32

(52) U.S. Cl. CPC G06Q 10/0635; G06Q 2220/00; H04L 9/3263

(57) ABSTRACT

Disclosed herein are methods, systems, and media for obtaining a user's risk assessment information. An example method includes obtaining risk assessment information by performing risk assessment on a user; obtaining the user's digital identity; creating a first verifiable claim based on the digital identity and risk assessment information using a first blockchain, wherein the first verifiable claim comprises the risk assessment information; uploading the first verifiable claim to a second blockchain and obtaining a storage credential of the first verifiable claim in the second blockchain; generating a risk assessment card for the user based on the storage credential and the first verifiable claim, wherein the second blockchain is connected to a service processing platform; and providing access to the service processing platform to obtain the risk assessment information of the user from the second blockchain in response to determining that the service processing platform uses the risk assessment card.

### CROSS-REFERENCE TO RELATED APPLICATIONS

This application claims priority to Chinese Patent Application No. 202010997262.5, filed on Sep. 21, 2020, which is hereby incorporated by reference in its entirety.

### TECHNICAL FIELD

The present document relates to the field of blockchain technologies, and in particular, to blockchain-based service processing methods and apparatuses.

### BACKGROUND

A blockchain is a new application mode of computer technologies such as distributed data storage, point-to-point transmission, a consensus mechanism, and an encryption algorithm. In a blockchain system, data blocks are connected in chronological order and combined into a linked data structure, and the blockchain system is a distributed ledger that cannot be tampered with or forged, which is guaranteed by using cryptography. In essence, the blockchain is a shared database. Due to features of the blockchain such as decentralization, tamper-resistance of information, and autonomy, the blockchain is increasingly valued and applied.

### SUMMARY

Embodiments of the present specification provide a blockchain-based service processing method. The method includes: obtaining risk assessment information obtained by performing risk assessment on a target user; obtaining digital identity information corresponding to the target user; creating a first verifiable claim of the risk assessment information corresponding to the digital identity information based on the digital identity information and the risk assessment information by using a first blockchain; and uploading content data of the first verifiable claim to a second blockchain, obtaining a storage credential of the content data of the first verifiable claim in the second blockchain, and generating a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a blockchain-based service processing method, applied to a first blockchain. The method includes: receiving digital identity information corresponding to a target user and risk assessment information that are uploaded by an authorization management platform; creating a first verifiable claim of the risk assessment information corresponding to the digital identity information based on the digital identity information and the risk assessment information; and returning content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a blockchain-based service processing apparatus. The apparatus includes: a first acquisition module, configured to obtain risk assessment information obtained by performing risk assessment on a target user and sent by a service processing platform; a second acquisition module, configured to obtain digital identity information corresponding to the target user; a first execution module, configured to create a first verifiable claim of the risk assessment information corresponding to the digital identity information based on the digital identity information and the risk assessment information by using a first blockchain; and a second execution module, configured to upload content data of the first verifiable claim to a second blockchain, obtain a storage credential of the content data of the first verifiable claim in the second blockchain, and generate a risk assessment card corresponding to the target user based on the storage credential and the first verifiable claim. The content data of the first verifiable claim includes the risk assessment information. The second blockchain is connected to the service processing platform, and the risk assessment card is used by the service processing platform to obtain the risk assessment information of the target user from the second blockchain.

Embodiments of the present specification further provide a blockchain-based service processing apparatus, applied to a first blockchain. The apparatus includes: a receiving module, configured to receive digital identity information corresponding to a target user and risk assessment information that are uploaded by an authorization management platform; a creating module, configured to create a first verifiable claim of the risk assessment information corresponding to the digital identity information based on the digital identity information and the risk assessment information; and a returning module, configured to return content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a blockchain-based service processing device, including: a processor; and a memory, arranged to store computer-executable instructions, where the executable instructions enable, when being executed, the processor to: obtain risk assessment information obtained by performing risk assessment on a target user; obtain digital identity information corresponding to the target user; create a first verifiable claim of the risk assessment information corresponding to the digital identity information based on the digital identity information and the risk assessment information by using a first blockchain; and upload content data of the first verifiable claim to a second blockchain, obtain a storage credential of the content data of the first verifiable claim in the second blockchain, and generate a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a blockchain-based service processing device, applied to a first blockchain. The devices includes: a processor; and a memory, arranged to store computer-executable instructions, where the executable instructions enable, when being executed, the processor to: receive digital identity information corresponding to a target user and risk assessment information that are uploaded by an authorization management platform; create a first verifiable claim of the risk assessment information corresponding to the digital identity information based on the digital identity information and the risk assessment information; and return content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a storage medium, configured to store computer-executable instructions, where the executable instructions implement the following process when being executed: obtaining risk assessment information obtained by performing risk assessment on a target user; obtaining digital identity information corresponding to the target user; creating a first verifiable claim of the risk assessment information corresponding to the digital identity information based on the digital identity information and the risk assessment information by using a first blockchain; and uploading the content data of the first verifiable claim to a second blockchain, obtaining a storage credential of the content data of the first verifiable claim in the second blockchain, and generating a risk assessment card corresponding to the target user based on the storage credential and the first verifiable claim. The content data of the first verifiable claim includes the risk assessment information. The second blockchain is connected to a service processing platform, and the risk assessment card is used by the service processing platform to obtain the risk assessment information of the target user from the second blockchain.

Embodiments of the present specification further provide a storage medium, applied to a first blockchain. The storage medium is configured to store computer-executable instructions, and the executable instructions implement the following process when being executed: receiving risk assessment information obtained by performing risk assessment on a target user and sent by a service processing platform; obtaining digital identity information corresponding to the target user; creating a first verifiable claim of the risk assessment information corresponding to the digital identity information based on the digital identity information and the risk assessment information by using the first blockchain; and uploading content data of the first verifiable claim to a second blockchain, obtaining a storage credential of the content data of the first verifiable claim in the second blockchain, and generating a risk assessment card corresponding to the target user based on the storage credential and the first verifiable claim. The second blockchain is connected to the service processing platform, and the risk assessment card is used by the service processing platform to obtain the risk assessment information of the target user from the second blockchain.

### BRIEF DESCRIPTION OF DRAWINGS

To describe technical solutions in the embodiments of the present specification or in the existing technology more clearly, the following briefly describes the accompanying drawings required for describing the embodiments or the existing technology. Clearly, the accompanying drawings in the following description show merely some embodiments of the present application, and a person of ordinary skill in the art can still derive other drawings from these accompanying drawings without creative efforts.

FIG. 1 is a schematic diagram 1 illustrating an application scenario of a blockchain-based service processing method, according to embodiments of the present specification;

FIG. 2 is a first schematic flowchart illustrating a blockchain-based service processing method, according to embodiments of the present specification;

FIG. 3(a) is a schematic diagram 1 of an interface for generating a risk assessment card in a blockchain-based service processing method, according to embodiments of the present specification;

FIG. 3(b) is a schematic diagram 2 of an interface for generating a risk assessment card in a blockchain-based service processing method, according to embodiments of the present specification;

FIG. 3(c) is a schematic diagram 3 of an interface for generating a risk assessment card in a blockchain-based service processing method, according to embodiments of the present specification;

FIG. 3(d) is a schematic diagram 4 of an interface for generating a risk assessment card in a blockchain-based service processing method, according to embodiments of the present specification;

FIG. 3(e) is a schematic diagram 5 of an interface for generating a risk assessment card in a blockchain-based service processing method, according to embodiments of the present specification;

FIG. 4(a) is a schematic diagram 1 of an interface for authorizing a service processing platform to use a risk assessment card in a blockchain-based service processing method, according to embodiments of the present specification;

FIG. 4(b) is a schematic diagram 2 of an interface for authorizing a service processing platform to use a risk assessment card in a blockchain-based service processing method, according to embodiments of the present specification;

FIGS. 5A-5B show a second schematic flowchart illustrating a blockchain-based service processing method, according to embodiments of the present specification;

FIG. 6 is a third schematic flowchart illustrating a blockchain-based service processing method, according to embodiments of the present specification;

FIG. 7 is a schematic module assembly diagram 1 illustrating a blockchain-based service processing apparatus, according to embodiments of the present specification;

FIG. 8 is a schematic module assembly diagram 2 illustrating a blockchain-based service processing apparatus, according to embodiments of the present specification; and

FIG. 9 is a schematic structural diagram illustrating a blockchain-based service processing device, according to embodiments of the present specification.

### DESCRIPTION OF EMBODIMENTS

To make a person skilled in the art understand the technical solutions in the embodiments of the present specification better, the following clearly and comprehensively describes the technical solutions in the embodiments of the present specification with reference to the accompanying drawings in the embodiments of the present specification. Clearly, the described embodiments are merely some but not all of the embodiments of the present document. All other embodiments obtained by a person of ordinary skill in the art based on the embodiments of the present specification without creative efforts shall fall within the protection scope of the present document.

At present, the general rule of financial services requires that ordinary investors should match risk levels of fund products or services. Therefore, when a user requests a risk-related service (for example, purchases a financial or fund product, etc.) in a financial institution, risk assessment needs to be performed on the user. The risk assessment means assessing risk tolerance of a user to obtain a risk tolerance level of the user, such as conservative and robust. By performing risk assessment on a user, a financial institution can provide the user with a product or service that matches risk tolerance of the user based on a risk assessment result. Therefore, the financial institution needs to be allowed by the user to obtain the risk assessment result of the user and other basic user information. To ensure security and privacy of user information, more financial institutions start to introduce blockchains to store information. In this scenario, risk assessment information of a user needs to be stored and managed in a blockchain, and it needs to be ensured that a financial institution connected to the blockchain can safely and effectively obtain storage data of the user from the blockchain.

Based on this need, the embodiments of the present specification provide blockchain-based service processing methods, apparatuses, devices, and storage mediums.

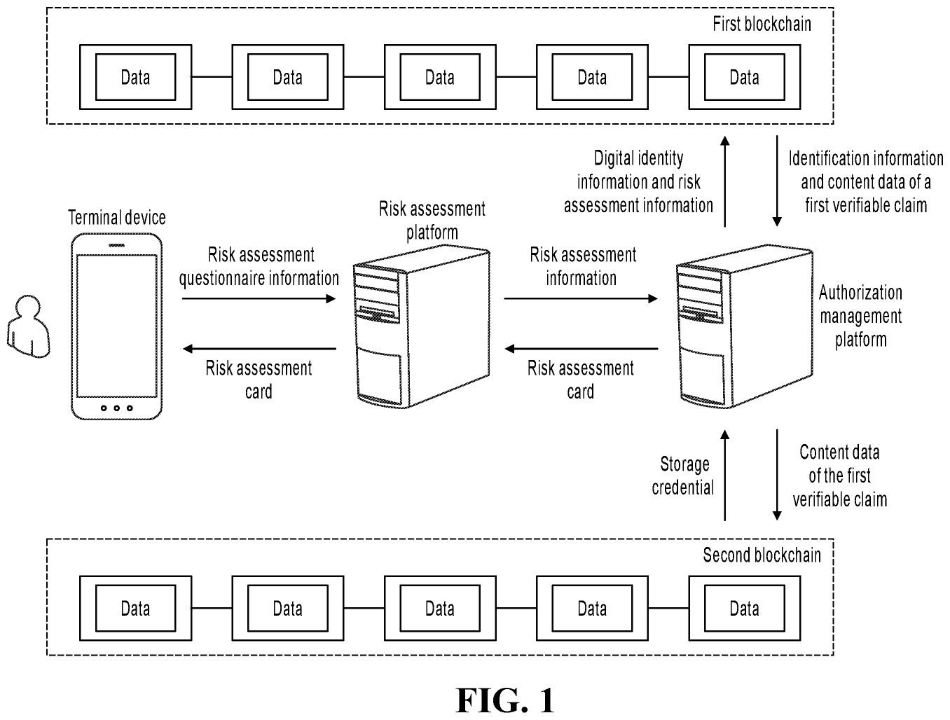

FIG. 1 is a schematic diagram illustrating an application scenario of a blockchain-based service processing method, according to embodiments of the present specification. As shown in FIG. 1, the application scenario includes a terminal device, a risk assessment platform, an authorization management platform, a first blockchain, and a second blockchain. The terminal device can be a mobile phone, a tablet computer, a computer, etc. A service client application is installed in the terminal device. The service client application can be an independent application (APP) installed in the terminal device, can be an applet embedded in some independent applications, or can be a web page, etc. The risk assessment platform can be a service processing platform connected to the second blockchain.

Specifically, when a user needs to perform service processing related to risk assessment, the user first performs a risk assessment operation in the terminal device, for example, fills in a risk assessment questionnaire in the service client application, and the service client application uploads risk assessment questionnaire information filled in by the user to the risk assessment platform. The risk assessment platform generates corresponding risk assessment information based on the risk assessment questionnaire information of the user. The risk assessment information can include a risk assessment result, service serial number information of the risk assessment service, user identification information, account information, etc. The risk assessment platform sends the generated risk assessment information to the authorization management platform. The authorization management platform obtains digital identity information of the user, where the digital identity information can be, for example, a decentralized identity (DID); and uploads the digital identity information of the user and the risk assessment information to the first blockchain, to create a first verifiable claim (VC) corresponding to the risk assessment information of the digital identity information and set status information of content data of the first verifiable to a valid state by using the first blockchain, where the status information of the first verifiable claim is maintained in the first blockchain. The first blockchain returns the content data of the created first verifiable claim to the authorization management platform, to upload the content data of the first verifiable claim to the second blockchain for storage and obtain a storage credential returned by the second blockchain by using the authorization management platform. The authorization management platform generates a risk assessment card based on the storage credential and the first verifiable claim, and returns the risk assessment card to the risk assessment platform, to return the risk assessment card to the target user by using the risk assessment platform. The generated risk assessment card is used by the service processing platform connected to the second blockchain to obtain the risk assessment information stored in the second blockchain from the second blockchain. Optionally, when obtaining the risk assessment information, the service processing platform can first search the authorization management platform for the storage credential corresponding to the first verifiable claim based on the first verifiable claim in the risk assessment card, and then obtain the content data (i.e., the risk assessment information) of the first verifiable claim from the second blockchain based on the storage credential. The storage credential can be a hash value.

Specifically, that the user performs service processing related to risk assessment can be: the user requests to perform risk assessment; or the target user is triggered to perform the risk assessment service if the service processing platform does not detect risk assessment information of the target user when the target user performs a risk-related service (for example, purchases a financial product).

Further, during risk assessment, alternatively, the user can switch from an authorization management client application serving as an entry to the risk assessment platform for risk assessment. This service scenario includes a terminal device, the risk assessment platform, an authorization management platform, a first blockchain, and a second blockchain. A service client application and the authorization management client application are installed in the terminal device. When performing the risk assessment service, the user requests to perform risk assessment in the authorization management client application and then switches to the service client application for specific risk assessment. Optionally, during specific implementation, switching to the service client application can be implemented through JSBridge remote invocation. An operation process performed after the switching to the service client application is the same as the operation process in the application scenario shown in FIG. 1. For details, references can be made to the application scenario shown in FIG. 1. Details are omitted here for simplicity.

Optionally, in a specific implementation, if the user performs risk assessment at an entry of the authorization management client application, the authorization management client application can obtain assessment questionnaire information needed for assessment from the risk assessment platform. Then, the user fills in the assessment questionnaire information in the authorization management client application, and then the authorization management platform generates corresponding risk assessment information based on the assessment questionnaire information of the assessment questionnaire filled in by the user. In this case, the authorization management platform directly generates the risk assessment information. After generating the risk assessment information of the target user, the authorization management platform obtains digital identity information corresponding to the target user, and then creates a first verifiable claim of the risk assessment information corresponding to the digital identity information based on the digital identity information and the risk assessment information by using the first blockchain. The authorization management platform uploads content data of the created first verifiable claim to the second blockchain, obtains a storage credential of the content data of the first verifiable claim in the second blockchain, and generates a risk assessment card corresponding to the target user based on the storage credential and the first verifiable claim. The second blockchain is connected to multiple service processing platforms, and the risk assessment card is used by the multiple service processing platforms to obtain the risk assessment information of the target user from the second blockchain. In this case, the authorization management platform returns the generated risk assessment card to the authorization management client application.

Certainly, the previously described scenarios are both described by using an example that the first blockchain creates the first verifiable claim. However, the first verifiable claim can alternatively be created on the authorization management platform or created by other authority institutions. Implementations are not listed one by one in the embodiments of the present specification.

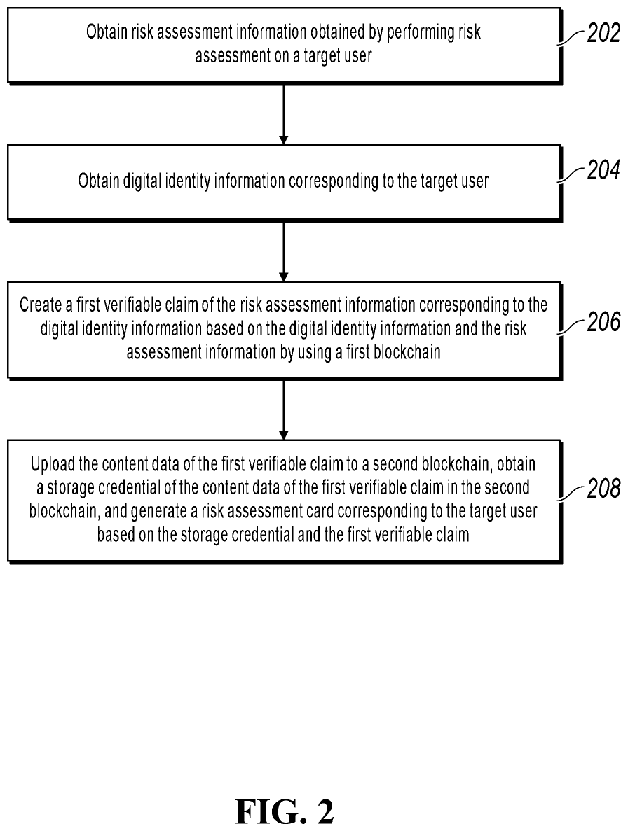

FIG. 2 is a first method flowchart illustrating a blockchain-based service processing method, according to embodiments of the present specification. The method shown in FIG. 2 is applied to an authorization management platform, i.e., the method is performed by the authorization management platform. As shown in FIG. 2, the method includes at least the following steps.

Step 202: Obtain risk assessment information obtained by performing risk assessment on a target user.

Specifically, in step 202, risk assessment information sent by a risk assessment platform can be received, or risk assessment information obtained by performing risk assessment on the target user on the authorization management platform can be obtained.

In a specific application scenario, the risk assessment platform can be a risk-related service processing platform, a risk-related service can be a financial service, and the corresponding service processing platform is a financial institution platform.

Optionally, in a specific implementation, the risk assessment information includes at least a risk assessment result, such as conservative or robust. Certainly, in addition to the risk assessment result, the risk assessment information can further include any one or more types of user identification information of the target user on the risk assessment platform, information about an account logged in to by the target user during risk assessment, risk assessment number information of the risk assessment performed on the target user, a service serial number of the risk assessment performed on the target user, time information of the risk assessment performed on the target user, identification information of the risk assessment platform that performs risk assessment on the user, etc. Certainly, in addition to the listed content, content included in the risk assessment information can further include other content. Only several possible types of information are listed above as examples, without constituting limitations on the embodiments of the present specification.

Specifically, when risk assessment needs to be performed on the user, the user usually needs to fill in a risk assessment questionnaire in a service client application, and sends risk assessment questionnaire information filled in by the user to the risk assessment platform. The risk assessment platform performs calculation based on a risk assessment model by using the risk assessment questionnaire information and collected income information, asset information, family information, and historical purchase financial information of the target user, to obtain the risk assessment result corresponding to the target user. Then, the risk assessment platform sends the generated risk assessment result and other related information (such as the previously listed user identification information, account information, risk assessment number information, service serial number, and risk assessment time information) as the risk assessment information to the authorization management platform.

Step 204: Obtain digital identity information corresponding to the target user.

After obtaining the risk assessment information of the target user, the authorization management platform performs the operation of obtaining the digital identity information corresponding to the target user.

The digital identity information can have multiple representations, and one possible representation is, for example, a DID.

Step 206: Create a first verifiable claim of the risk assessment information corresponding to the digital identity information based on the digital identity information and the risk assessment information by using a first blockchain.

Content data of the first verifiable claim includes the risk assessment information.

Optionally, in the embodiments of the present specification, the content data of the first verifiable claim can also be understood as claim content of the first verifiable claim. The first verifiable claim is used to claim the risk assessment information corresponding to the digital identity information.

Optionally, in step 206, the creating a first verifiable claim includes at least two specific implementations: performing the operation of creating the first verifiable claim in the first blockchain or performing the operation of creating the first verifiable claim on the authorization management platform. Identification information and the content data of the first verifiable claim need to be generated regardless of whether the first verifiable claim is created in the first blockchain or on the authorization management platform.

Optionally, in a specific implementation, the first blockchain can be a DID blockchain.

Specifically, in the embodiments of the present specification, in addition to including the risk assessment information (i.e., claiming the risk assessment information), the content data of the first verifiable claim can further include any one or more types of the following information: the number information of the risk assessment information, the digital identity information of the target user, digital identity information of the risk assessment platform that performs risk assessment, and generation time information of the risk assessment information.

Step 208: Upload the content data of the first verifiable claim to a second blockchain, obtain a storage credential of the content data of the first verifiable claim in the second blockchain, and generate a risk assessment card corresponding to the target user based on the storage credential and the first verifiable claim.

The second blockchain is connected to a service processing platform, and the risk assessment card is used by the service processing platform to obtain the risk assessment information of the target user from the second blockchain.

In the embodiments of the present specification, one or more service processing platforms can be connected to the second blockchain. Implementations are not limited in the embodiments of the present specification.

Optionally, in a specific implementation, the second blockchain can be a consortium chain, and correspondingly the service processing platform connected to the second blockchain is a member of the consortium chain.

Specifically, the authorization management platform uploads the claim content of the first verifiable claim to the second blockchain for storage. After receiving the content data of the first verifiable claim uploaded by the authorization management platform, the second blockchain returns the storage credential of the content data of the first verifiable claim in the second blockchain to the authorization management platform. The authorization management platform generates the risk assessment card corresponding to the target user based on the storage credential and the first verifiable claim. As such, the service processing platform can access the content data of the first verifiable claim from the second blockchain, i.e., obtain the risk assessment information from the second blockchain by using the risk assessment card.

Optionally, in a specific implementation, the authorization management platform can use the credential data together with the first verifiable claim as content information of the risk assessment card. For example, the authorization management platform can associate the credential data with the risk assessment number information in the content data of the first verifiable claim as the risk assessment card. Certainly, the risk assessment number information can be obtained from the content data of the first verifiable claim, or can be obtained from the risk assessment information stored in the authorization management platform. Alternatively, the authorization management platform can associate the credential data with the identification information of the first verifiable claim as the content information of the risk assessment card. Actually, the risk assessment card in the embodiments of the present specification is a credential used by the user to obtain the content data of the first verifiable claim from the second blockchain. Therefore, in an optional implementation, the risk assessment card can include only the storage credential. Certainly, the risk assessment card can alternatively include other content provided that the risk assessment card includes a related credential that can be used to obtain the content data of the first verifiable claim from the second blockchain. Specific content of the risk assessment card is not limited in the embodiments of the present specification.

Optionally, in other specific implementations, the authorization management platform can return the identification information of the first verifiable claim as the risk assessment card to the target user, and store the storage credential in the authorization management platform. As such, when the service processing platform needs to obtain the risk assessment information of the target user, the service processing platform first searches the authorization management platform for the storage credential corresponding to the first verifiable claim based on the identification information of the first verifiable claim, and then searches the second blockchain for the content data of the first verifiable claim based on the storage credential, to obtain the risk assessment information of the target user. That is, in the embodiments of the present specification, the risk assessment card can be generated based on only the first verifiable claim, or can be generated based on only the storage credential, or can be generated based on both the first verifiable claim and the storage credential. Implementations are not limited in the embodiments of the present specification.

Certainly, only several possible implementations are listed in the embodiments of the present specification as examples, without constituting limitations on the embodiments of the present specification.

The storage credential can be a hash value corresponding to the content data of the first verifiable claim and generated by the second blockchain.

According to the blockchain-based service processing method provided in the embodiments of the present specification, when obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information. In addition, the risk assessment information is stored in the blockchain, thereby ensuring that the risk assessment information cannot be tampered with, i.e., ensuring security and authenticity of risk assessment data.

To facilitate understanding of the method provided in the embodiments of the present specification, the following describes in detail specific implementation processes of the previously described steps.

Optionally, in a specific implementation, for a target user, risk assessment may be performed on the target user for multiple times, and different risk assessment information may be generated each time. That is, the risk assessment information of the user needs to be updated. However, after the content data (including the risk assessment information) of the first verifiable claim is written to the second blockchain, the data in the second blockchain cannot be deleted, modified, etc. Therefore, to update the risk assessment information of the target user, in the embodiments of the present specification, status information of the first verifiable claim is marked in the first blockchain. The status information is used to represent whether the content data of the first verifiable claim is valid. When the status information is set to a valid state, the content data of the first verifiable claim is valid. When the status information is set to an invalid state, the content data of the first verifiable claim is invalid. As such, after the risk assessment information of the user is updated, the first verifiable claim corresponding to the original risk assessment information can be marked as an invalid state, and a first verifiable claim of new risk assessment information can be marked as a valid state, thereby updating the risk assessment information of the user.

Therefore, in the embodiments of the present specification, the first blockchain stores the status information representing whether the content data of the first verifiable claim is valid, and the status information is set to valid when the first verifiable claim is created.

Optionally, in a specific implementation, if the first verifiable claim is created by the first blockchain, the status information of the created first verifiable claim is directly marked as a valid state after the first verifiable claim is created.

Optionally, if the first verifiable claim is created by the authorization management platform, the authorization management platform can write the status information (valid state) of the first verifiable claim and the corresponding identification information of the first verifiable claim to the first blockchain; or the authorization management platform can write the identification information of the first verifiable claim to the first blockchain after creating the first verifiable claim, and the first blockchain can mark the status information of the first verifiable claim as a valid state after receiving the identification information of the first verifiable claim.

Optionally, in a specific implementation, in step 204, the obtaining digital identity information corresponding to the target user can include at least the following two implementations:

Method 1:

Pre-generated digital identity information corresponding to users is searched for the digital identity information corresponding to the target user.

Optionally, when the target user performs a service on the authorization management platform not for the first time, the digital identity information corresponding to the target user has been created when the target user performs a service on the authorization management platform for the first time. Therefore, when performing a service on the authorization management platform for the second time, the third time, etc., the target user only needs to directly search the various pieces of digital identity information stored in the authorization management platform for the digital identity information corresponding to the target user. Specifically, the authorization management platform can store mapping relationships between user identification information and digital identity information of users.

In addition, in other specific implementations, regardless of whether the user executes a service on the authorization management platform, the authorization management platform can pre-create the digital identity information corresponding to the users. As such, when the target user needs to execute a service by using the authorization management platform, the target user only needs to directly search the digital identity information corresponding to the users and stored in the authorization management platform for the digital identity information corresponding to the target user.

Optionally, during specific implementation, the authorization management platform can create the digital identity information of the target user based on the user identification information corresponding to the target user on the service processing platform, or can create the digital identity information corresponding to the target user based on the information about the account logged in to by the target user on the service processing platform. Specifically, the authorization management platform can obtain the previously described information of the users from the service processing platform, and create the digital identity information of the users based on the obtained information and store the digital identity information.

Method 2:

The digital identity information of the target user is created based on the user identification information corresponding to the target user on the service processing platform or the information about the account logged in to by the target user during the risk assessment on the service processing platform.

Specifically, when the target user performs a service by using the authorization management platform for the first time, the digital identity information corresponding to the target user needs to be created. When the digital identity information is created, the digital identity information can be created based on the user identification information corresponding to the target user on the service processing platform, or can be created based on the information about the account logged in to by the target user during the risk assessment on the service processing platform. Specific information used as a basis of creating the digital identity information can be set based on actual application needs, and is not limited in the embodiments of the present specification.

In addition, it should be noted that, the same user may register multiple accounts on the service processing platform. Therefore, when the digital identity information is created based on account information of the target user on the service processing platform, the digital identity information can be created based on the information about the account logged in to by the user during the risk assessment on the service processing platform. For example, if the target user logs in to account A on the service processing platform for risk assessment, the authorization management platform creates the digital identity information of the target user based on account A after receiving the risk assessment information of the target user sent by the service processing platform.

In the embodiments of the present specification, after the digital identity information corresponding to the target user is obtained, the operation of creating the first verifiable claim of the risk assessment information corresponding to the digital identity information of the target user needs to be performed based on the digital identity information of the target user and the risk assessment information, i.e., step 206 needs to be performed.

Specifically, in the embodiments of the present specification, in step 206, the creating a first verifiable claim of the risk assessment information corresponding to the digital identity information based on the digital identity information and the risk assessment information by using a first blockchain includes at least the following two cases: One case is creating the first verifiable claim in the first blockchain, and the another case is creating the first verifiable claim on the authorization management platform. The following respectively describes specific implementation processes of the two cases in detail.

First Case:

The digital identity information and the risk assessment information are sent to the first blockchain, to create the first verifiable claim based on the digital identity information and the risk assessment information by using the first blockchain; and the identification information of the first verifiable claim and the content data of the first verifiable claim are obtained from the first blockchain.

Optionally, in a specific implementation, the authorization management platform can send a creation request of the first verifiable claim to the first blockchain. The creation request includes the digital identity information of the target user and the risk assessment information. After receiving the creation request sent by the authorization management platform, the first blockchain creates the first verifiable claim based on the digital identity information and the risk assessment information in the creation request. The created first verifiable claim is used to claim the risk assessment information corresponding to the digital identity information. After creating the first verifiable claim, the first blockchain returns the first verifiable claim to the authorization management platform. Specifically, the first blockchain can return the identification information and the content data of the first verifiable claim to the authorization management platform. After receiving the identification information and the content data of the first verifiable claim that are returned by the first blockchain, the authorization management platform uploads the content data of the first verifiable claim to the second blockchain. In addition, after creating the first verifiable claim, the first blockchain records the status information of the created first verifiable claim as a valid state. The status information is used to represent that the content data of the first verifiable claim is valid.

Specifically, the first blockchain is used to maintain only the identification information of the first verifiable claim and the corresponding status information, and does not store the content data of the first verifiable claim. Therefore, in a specific implementation, the first blockchain stores a mapping relationship between the identification information of the first verifiable claim and the status information corresponding to the identification information of the first verifiable claim.

In addition, it should be noted that, in addition to the risk assessment result of the target user, the risk assessment information can further include any one or more types of the following information: the number information of the risk assessment information, the digital identity information of the service processing platform, the generation time information of the risk assessment information, etc.

Second Case:

The first verifiable claim of the risk assessment information corresponding to the digital identity information is created based on the digital identity information and the risk assessment information; and the identification information of the first verifiable claim is written to the first blockchain.

Optionally, in a specific implementation, after obtaining the digital identity information corresponding to the target user, the authorization management platform creates the first verifiable claim of the risk assessment information corresponding to the digital identity information based on the digital identity information corresponding to the target user and the risk assessment information. The created first verifiable claim is used to claim the risk assessment information corresponding to the digital identity information. Specifically, the created first verifiable claim includes the identification information of the first verifiable claim and the content data of the first verifiable claim. After creating the first verifiable claim, the authorization management platform writes the identification information of the first verifiable claim to the first blockchain. After receiving the identification information of the first verifiable claim, the first blockchain sets the status information used to represent whether the content data of the first verifiable claim is valid to a valid state, and stores a mapping relationship between the identification information of the first verifiable claim and the status information of the first verifiable claim. In addition, the first blockchain is only responsible for storing the mapping relationship between the identification information of the first verifiable claim and the status information of the first verifiable claim, and is not responsible for storing the content data of the first verifiable claim. Therefore, in the embodiments of the present specification, the authorization management platform writes the content data of the first verifiable claim to the second blockchain after creating the first verifiable claim.

It should be noted that, for the case that the authorization management platform creates the first verifiable claim, the authorization management platform can alternatively write the status information of the first verifiable claim to the first blockchain, i.e., the authorization management platform correspondingly writes the identification information of the first verifiable claim and the status information of the first verifiable claim to the first blockchain. After receiving the information, the first blockchain stores the mapping relationship between the identification information and the status information of the first verifiable claim.

Specifically, in the embodiments of the present specification, the content data of the first verifiable claim needs to be written to the second blockchain after the first verifiable claim is created, i.e., step 208 needs to be performed. In the embodiments of the present specification, to further ensure security and privacy of user data, the content data of the first verifiable claim can be encrypted before being uploaded to the second blockchain. Therefore, in a specific implementation, the uploading the content data of the first verifiable claim to a second blockchain in step 208 specifically includes the following process:

The content data of the first verifiable claim is encrypted based on a public key corresponding to the digital identity information, to obtain ciphertext information corresponding to the content data of the first verifiable claim; and the ciphertext information is uploaded to the second blockchain.

Optionally, in a specific implementation, the public key corresponding to the digital identity information can be obtained from the first blockchain based on the digital identity information corresponding to the target user, and then the content data of the first verifiable claim can be encrypted by using the public key obtained from the first blockchain.

In the embodiments of the present specification, the content data of the first verifiable claim is encrypted by using the public key of the digital identity information corresponding to the target user, and correspondingly the ciphertext information can be decrypted only by using a private key corresponding to the digital identity information, and the private key is generally held by the user with the digital identity information. Therefore, security and privacy of the content data of the first verifiable claim can be further ensured.

Specifically, in the embodiments of the present specification, after the content data of the first verifiable claim is uploaded to the second blockchain, the second blockchain generates the storage credential (such as a hash value) corresponding to the content data of the first verifiable claim, and the authorization management platform obtains the storage credential from the second blockchain and stores the storage credential. In addition, the authorization management platform generates the risk assessment card corresponding to the risk assessment information of the target user based on the storage credential and the verifiable claim, and returns the risk assessment card to the risk assessment platform, so that the risk assessment platform displays the risk assessment card to the target user by using the service processing client application. Specifically, the risk assessment card can include the identification information of the first verifiable claim and the credential data, can include the identification information of the first verifiable claim, the status information of the first verifiable claim, and the credential data, can include only the identification information of the first verifiable claim, or can include the identification information of the first verifiable claim and the risk assessment result (such as robust or conservative). Only a few types of content are listed here as examples, without constituting limitations on the embodiments of the present specification.

Optionally, in a specific implementation, to prevent risk assessment from being repeatedly performed on the user when the same user performs risk-related services (for example, purchasing financial products) on different service processing platforms, the target user can authorize the service processing platform connected to the blockchain to use the risk assessment card by using the authorization management platform. Because the content data of the verifiable claim stored in the second blockchain can be obtained by using the risk assessment card, the service processing platform is authorized to use the risk assessment card, i.e., the service processing platform is authorized to obtain the risk assessment information of the target user.

Therefore, the method provided in the embodiments of the present specification further includes the following steps:

An authorization request sent by the target user is received, and a second verifiable claim is created based on the authorization request, where the authorization request is used to request to grant the service processing platform permission to obtain risk assessment information of the target user, and the second verifiable claim is used to claim that the service processing platform is granted permission to obtain risk assessment information of the target user.

The authorization request can be triggered by the target user by using an authorization management client application, or can be sent by the target user to the risk assessment platform by using the service client application and then sent by the risk assessment platform to the authorization management platform for authorization.

Optionally, in a specific implementation, the authorization request includes a list of service processing platforms (which can include one service processing platform or can include multiple service processing platforms) that need to be authorized and information about permission that needs to be granted. Correspondingly, the second verifiable claim is generated based on the list of service processing platforms and the information about the permission that needs to be granted.

The information about the permission that needs to be granted can be authorizing the service processing platform to use the risk assessment card to access the content data of the first verifiable claim (i.e., obtain the risk assessment information from the second blockchain). Therefore, the content data of the first verifiable claim includes at least risk assessment card information (such as indication information or card number information), the identification information of the first verifiable claim, etc.

The service processing platform is one or several of service processing platforms connected to the second blockchain.

Optionally, in a specific implementation, after the risk assessment card is issued to the target user, prompt information “whether to authorize the institution to use the risk assessment card” can be displayed on the authorization management client application. If the user taps a button “yes” or “authorize now”, an authorization page is entered. On this page, the user can select a service processing platform that the user wants to authorize. It should be noted that service processing platforms that display the authorization page are service processing platforms connected to the second blockchain. When the user selects the service processing platform that the user wants to authorize, an authorization request for authorizing the selected service processing platform to use the risk assessment card is sent to the authorization management platform.

After receiving the authorization request, the authorization management platform creates the second verifiable claim for the authorization request. Specifically, a specific creation process of the second verifiable claim can be performed on the authorization management platform, can be performed in the first blockchain, or can be performed in another authority institution. Implementations are not limited in the embodiments of the present specification.

Specifically, after the second verifiable claim is created, the method provided in the embodiments of the present specification further includes:

encrypting the second verifiable claim based on the public key corresponding to the digital identity information, to obtain ciphertext information corresponding to the second verifiable claim; and uploading the ciphertext information corresponding to the second verifiable claim to the second blockchain.

The public key corresponding to the digital identity information can be obtained from the first blockchain.

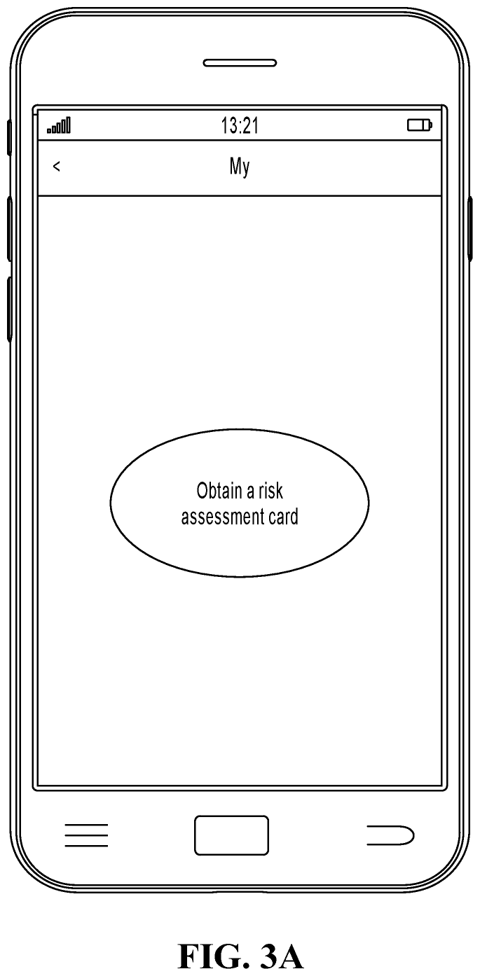

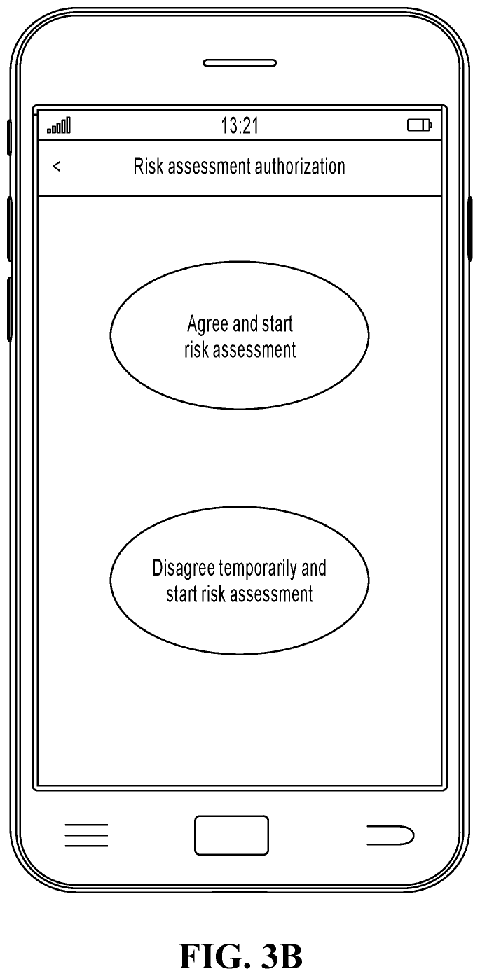

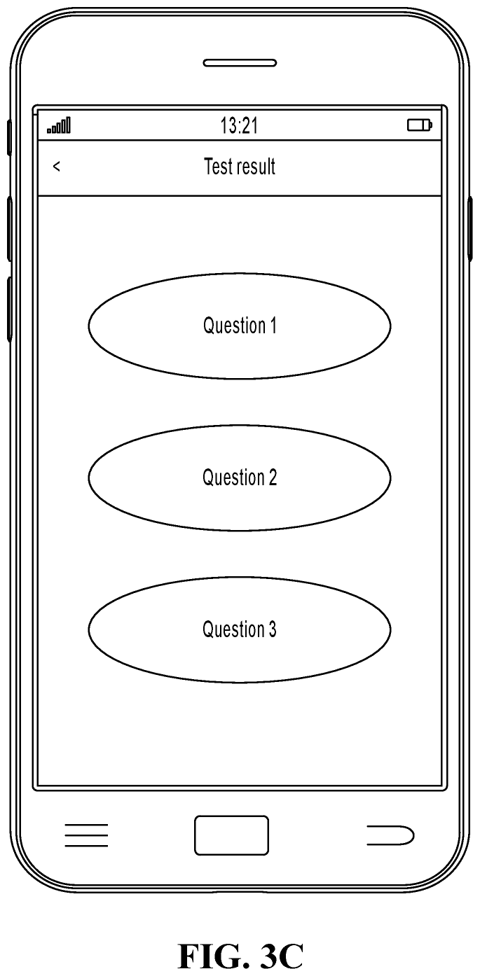

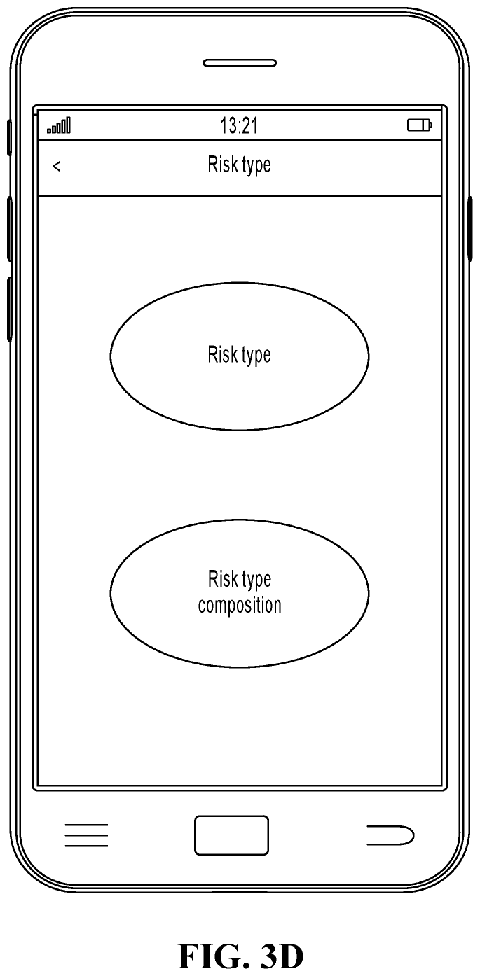

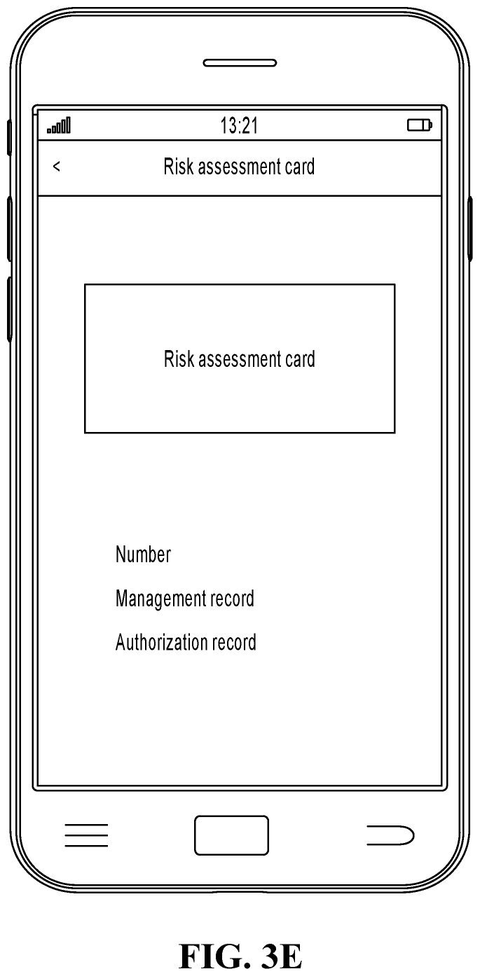

To facilitate understanding of the method provided in the embodiments of the present specification, the following describes the blockchain-based service processing method provided in the embodiments of the present specification with reference to interface diagrams. Specifically, diagrams of changes in an interface for obtaining a risk assessment card by a user are shown in FIG. 3(a) to FIG. 3(e). In an interface shown in FIG. 3(a), the user taps a button “obtain a risk assessment card” in the interface to switch to an interface shown in FIG. 3(b). The interface displays two buttons: “agree and start risk assessment” and “disagree temporarily and start risk assessment.” If the user taps “agree and start risk assessment,” it can be understood that after obtaining a risk assessment card, the user directly enters an interface for authoring a service processing platform to use the risk assessment card; or if the user taps “disagree temporarily and start risk assessment,” it can be understood that the user only obtains a risk assessment card but does not perform a process for authoring a service processing platform to use the risk assessment card. Regardless of a button tapped by the user, the user enters a risk assessment interface shown in FIG. 3(c). The interface shown in FIG. 3(c) lists questions that the user needs to answer during risk assessment. The user needs to answer the questions in the interface, and submit the answers to a risk assessment platform after answering the questions. The risk assessment platform returns risk assessment result information to the user. As shown in FIG. 3(d), the returned risk assessment result information can include a risk type and risk type composition. The risk assessment card is generated based on the risk assessment information, and a possible risk assessment card finally generated and displayed to the user is shown in FIG. 3(e).

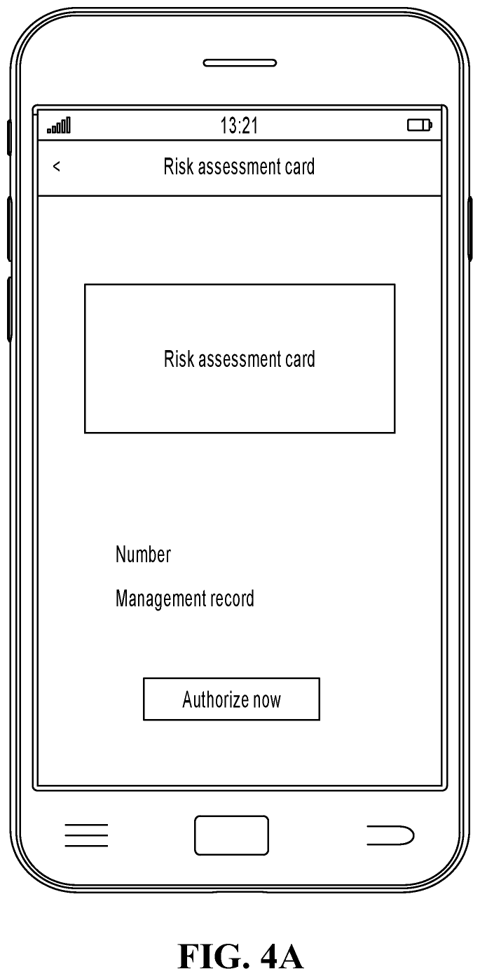

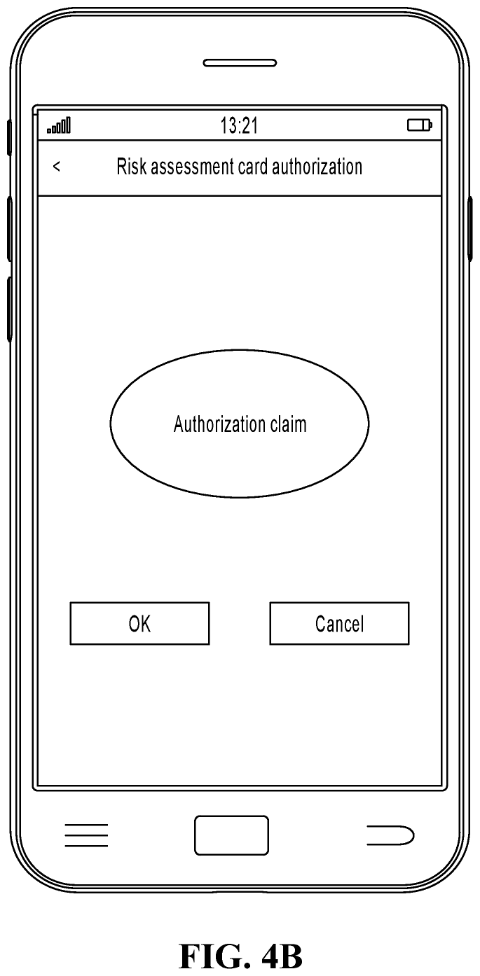

A flowchart illustrating an interface for authorizing, by a user, a service processing platform to use a risk assessment card is shown in FIG. 4(a) and FIG. 4(b). In an interface shown in FIG. 4(a), the user taps “authorize now” to enter an authorization interface shown in FIG. 4(b). The interface displays related content of an authorization claim. The user can complete authorization of a risk assessment card only by selecting a service processing platform that needs to be authorized from the content displayed in the authorization claim and submitting the service processing platform.

Certainly, the interfaces shown in FIG. 3(a) to FIG. 3(e) and FIG. 4(a) and FIG. 4(b) are all described as examples, without constituting limitations on the embodiments of the present specification.

To facilitate understanding of the methods provided in the embodiments of the present specification, the following describes the methods provided in the embodiments of the present specification by using an example that a first verifiable claim is created in a first blockchain and an example that a first verifiable claim is created on an authorization management platform.

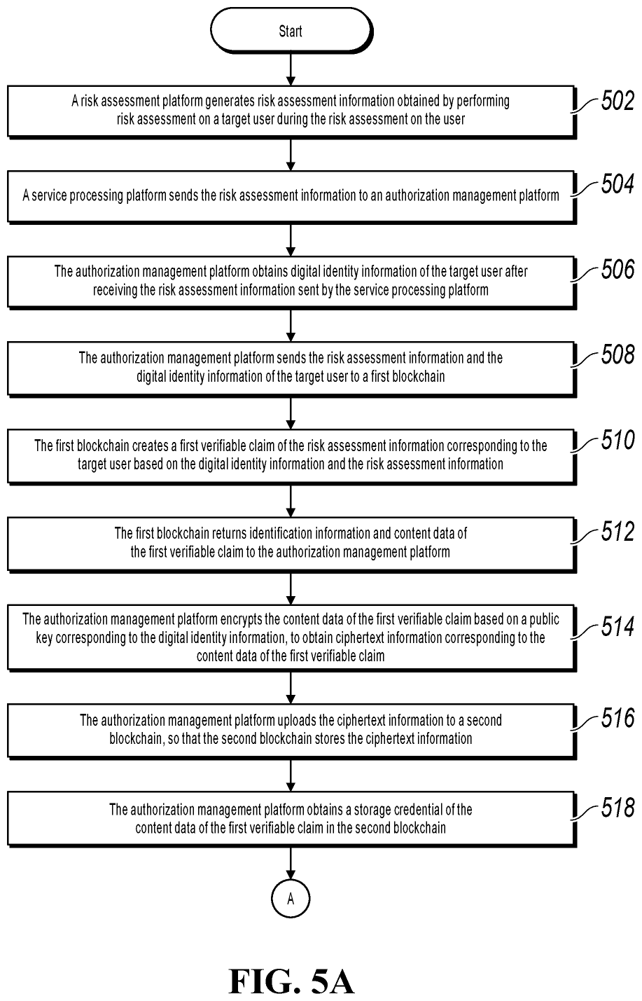

FIGS. 5A-5B show a second method flowchart illustrating a blockchain-based service processing method, according to embodiments of the present specification. As shown in FIGS. 5A-5B, the method includes at least the following steps.

Step 502: A risk assessment platform generates risk assessment information obtained by performing risk assessment on a target user during the risk assessment on the user.

The risk assessment information includes a risk assessment result (conservative, robust, etc.), risk assessment number information, identification information of the target user, account information of the target user, service serial number information of the risk assessment, etc.

Step 504: A service processing platform sends the risk assessment information to an authorization management platform.

Step 506: The authorization management platform obtains digital identity information of the target user after receiving the risk assessment information sent by the service processing platform.

Step 508: The authorization management platform sends the risk assessment information and the digital identity information of the target user to a first blockchain.

Step 510: The first blockchain creates a first verifiable claim of the risk assessment information corresponding to the target user based on the digital identity information and the risk assessment information.

Content data of the first verifiable claim includes the risk assessment information.

Step 512: The first blockchain returns identification information and the content data of the first verifiable claim to the authorization management platform.

Step 514: The authorization management platform encrypts the content data of the first verifiable claim based on a public key corresponding to the digital identity information, to obtain ciphertext information corresponding to the content data of the first verifiable claim.

Step 516: The authorization management platform uploads the ciphertext information to a second blockchain, so that the second blockchain stores the ciphertext information.

The second blockchain is connected to multiple service processing platforms.

Step 518: The authorization management platform obtains a storage credential of the content data of the first verifiable claim in the second blockchain.

Step 520: The authorization management platform generates a risk assessment card based on the storage credential and the first verifiable claim, to enable the service processing platform to obtain the risk assessment information from the second blockchain based on the risk assessment card.

Step 522: The authorization management platform issues the risk assessment card to the target user.

Step 524: The authorization management platform receives an authorization request for authorizing the service processing platform connected to the second blockchain.

The authorization request includes identification information and authorization information of the service processing platform.

Step 526: The authorization management platform creates a second verifiable claim based on the authorization request, where the second verifiable claim is used to claim that the service processing platform is granted permission to obtain risk assessment information of the target user.

Step 528: The authorization management platform encrypts the second verifiable claim based on the public key corresponding to the digital identity information, to obtain ciphertext information corresponding to the second verifiable claim.

Step 530: The authorization management platform uploads the ciphertext information corresponding to the second verifiable claim to the second blockchain for storage.

Step 532: The authorization management platform returns the second verifiable claim to the target user.

The blockchain-based service processing method provided in the embodiments of the present specification has at least the following beneficial effects: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, the identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

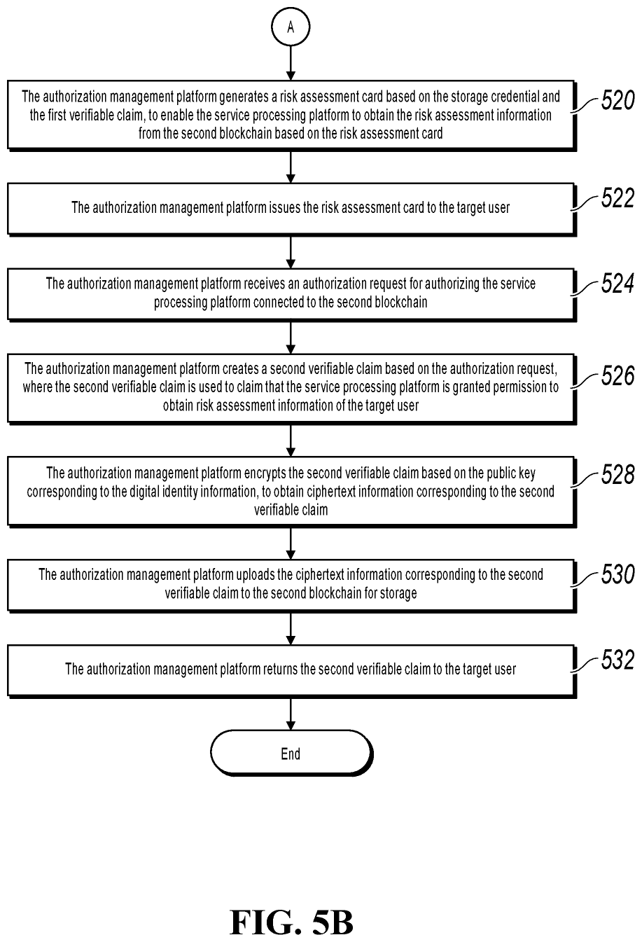

Corresponding to the methods provided in the embodiments shown in FIG. 2 to FIGS. 5A-5B in the present specification, based on the same idea, the embodiments of the present specification further provide a blockchain-based service processing method. The method is applied to a first blockchain. FIG. 6 is a third method flowchart illustrating a blockchain-based service processing method, according to embodiments of the present specification. As shown in FIG. 6, the method includes at least the following steps:

Step 602: Receive digital identity information corresponding to a target user and risk assessment information that are uploaded by an authorization management platform.

The risk assessment information can be sent by a risk assessment center to the authorization management platform, or can be generated by directly performing risk assessment on the user on the authorization management platform.

Step 604: Create a first verifiable claim of the risk assessment information corresponding to the digital identity information based on the digital identity information and the risk assessment information.

Content data of the first verifiable claim includes the risk assessment information.

Step 606: Return the content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim.

The second blockchain is connected to a service processing platform, and the risk assessment card is used by the service processing platform to obtain the risk assessment information of the target user from the second blockchain.

One or more service processing platforms can be connected to the second blockchain. Implementations are not limited in the embodiments of the present specification.

Optionally, the method provided in the embodiments of the present specification further includes: setting status information of the first verifiable claim to a valid state, where the status information is used to represent whether the content data of the first verifiable claim is valid.

Specifically, the status information of the first verifiable claim is marked as a valid state when the first verifiable claim is created, to represent that the content data of the first verifiable claim is valid. Specifically, a mapping relationship between the identification information and the status information of the first verifiable claim can be stored in the first blockchain.

Optionally, in a specific implementation, the content data of the first verifiable claim further includes at least one type of the following information: number information of the risk assessment information, the digital identity information of the target user, digital identity information of a risk assessment platform that performs risk assessment, and generation time information of the risk assessment information.

For specific implementation processes of the steps in the method provided in the embodiments of the present specification, references can be to the embodiments shown in FIG. 2 to FIGS. 5A-5B. Details are omitted here for simplicity.

The blockchain-based service processing method provided in the embodiments of the present specification has at least the following beneficial effects: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, the identification information of the first verifiable claim and the status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

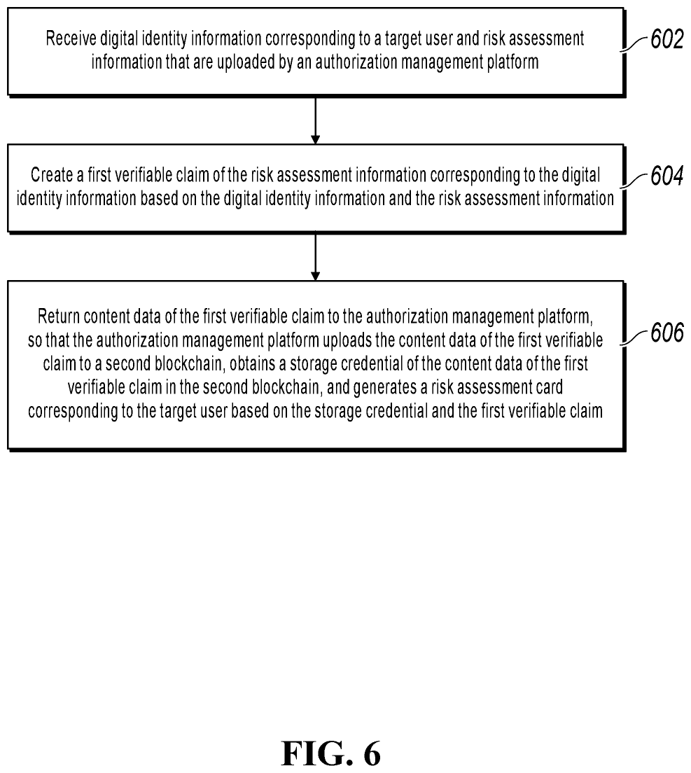

Corresponding to the methods provided in the embodiments shown in FIG. 2 to FIGS. 5A-5B in the present specification, based on the same idea, the embodiments of the present specification further provide a blockchain-based service processing apparatus, configured to perform the methods provided in the embodiments shown in FIG. 2 to FIGS. 5A-5B in the embodiments of the present specification. FIG. 7 is a schematic module assembly diagram illustrating a blockchain-based service processing apparatus, according to embodiments of the present specification. As shown in FIG. 7, the apparatus includes at least: a first acquisition module 702, configured to obtain risk assessment information obtained by performing risk assessment on a target user; a second acquisition module 704, configured to obtain digital identity information corresponding to the target user; a first execution module 706, configured to create a first verifiable claim of the risk assessment information corresponding to the digital identity information based on the digital identity information and the risk assessment information by using a first blockchain, where content data of the first verifiable claim includes the risk assessment information; and a second execution module 708, configured to upload the content data of the first verifiable claim to a second blockchain, obtain a storage credential of the content data of the first verifiable claim in the second blockchain, and generate a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The apparatuses provided in the embodiments of the present specification can implement all the method steps in the embodiments shown in FIG. 2 to FIGS. 5A-5B. Therefore, for specific implementation processes of functions corresponding to the apparatus, references can be made to the embodiments shown in FIG. 2 to FIGS. 5A-5B. Details are omitted here for simplicity.

The blockchain-based service processing apparatus provided in the embodiments of the present specification has at least the following beneficial effects: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

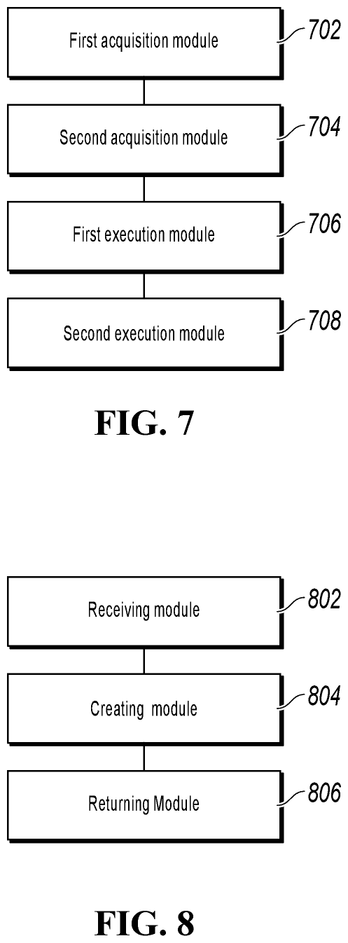

Corresponding to the method provided in the embodiments shown in FIG. 6 in the present specification, based on the same idea, the embodiments of the present specification further provide a blockchain-based service processing apparatus. The apparatus is applied to a first blockchain and is configured to perform the method provided in the embodiments shown in FIG. 6 in the embodiments of the present specification. FIG. 8 is a schematic module assembly diagram illustrating a blockchain-based service processing apparatus, according to embodiments of the present specification. As shown in FIG. 8, the apparatus includes at least: a receiving module 802, configured to receive digital identity information corresponding to a target user and risk assessment information that are uploaded by an authorization management platform; a creating module 804, configured to create a first verifiable claim of the risk assessment information corresponding to the digital identity information based on the digital identity information and the risk assessment information, where content data of the first verifiable claim includes the risk assessment information; and a returning module 806, configured to return the content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The apparatuses provided in the embodiments of the present specification can implement all the method steps in the embodiments shown in FIG. 6. Therefore, for specific implementation processes of functions corresponding to the apparatus, references can be made to the embodiments shown in FIG. 6. Details are omitted here for simplicity.

The blockchain-based service processing apparatus provided in the embodiments of the present specification has at least the following beneficial effects: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

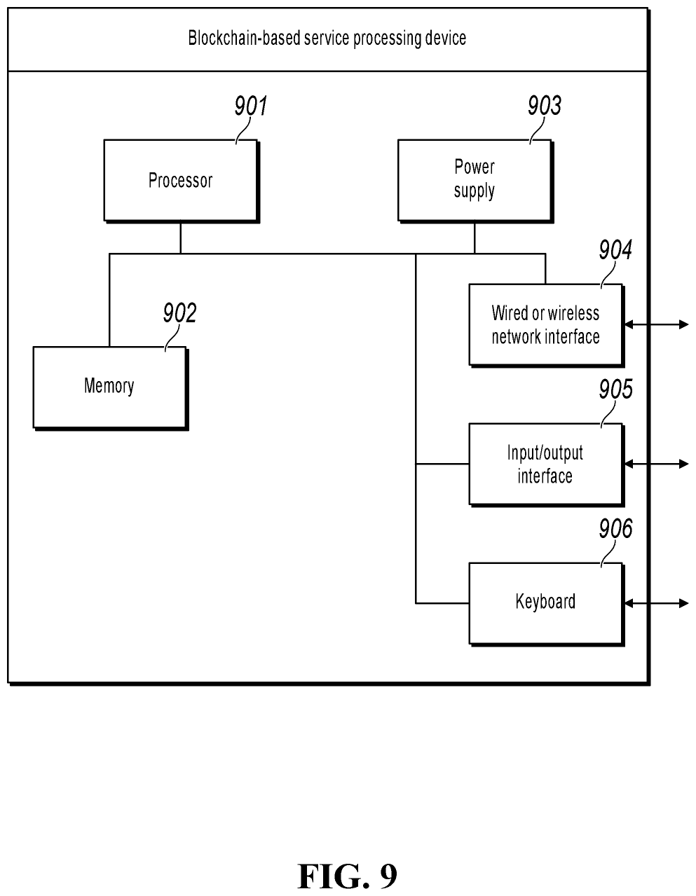

Further, based on the methods shown in FIG. 2 to FIGS. 5A-5B, the embodiments of the present specification further provide a blockchain-based service processing device, as shown in FIG. 9.

The blockchain-based service processing device can greatly vary with configuration or performance, and can include one or more processors 901 and one or more memories 902. The memory 902 can store one or more storage applications or data. The memory 902 can be a temporary storage or a persistent storage. The application stored in the memory 902 can include one or more modules (not shown in the figure), and each module can include a series of computer-executable instruction information for the blockchain-based service processing device. Further, the processor 901 can be configured to communicate with the memory 902, to execute a series of computer-executable instruction information in the memory 902 in the blockchain-based service processing device. The blockchain-based service processing device can further include one or more power supplies 903, one or more wired or wireless network interfaces 904, one or more input/output interfaces 905, one or more keyboards 906, etc.

In specific embodiments, the blockchain-based service processing device includes a memory and one or more programs. The one or more programs are stored in the memory. The one or more programs can include one or more modules. Each module can include a series of computer-executable instruction information for the blockchain-based service processing device. One or more processors are configured to execute the one or more programs, including the following computer-executable instruction information: obtaining risk assessment information obtained by performing risk assessment on a target user; obtaining digital identity information corresponding to the target user; creating a first verifiable claim of the risk assessment information corresponding to the digital identity information based on the digital identity information and the risk assessment information by using a first blockchain, where content data of the first verifiable claim includes the risk assessment information; and uploading the content data of the first verifiable claim to a second blockchain, obtaining a storage credential of the content data of the first verifiable claim in the second blockchain, and generating a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The devices provided in the embodiments of the present specification can implement all the method steps in the embodiments shown in FIG. 2 to FIGS. 5A-5B. Therefore, for specific implementation processes of functions corresponding to the device, references can be made to the embodiments shown in FIG. 2 to FIGS. 5A-5B. Details are omitted here for simplicity.

The blockchain-based service processing device provided in the embodiments of the present specification has at least the following beneficial effects: When obtaining the risk assessment information obtained by performing risk assessment on the target user, an authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

Further, based on the method shown in FIG. 6, the embodiments of the present specification further provide a blockchain-based service processing device, applied to a first blockchain. For a mechanism diagram of the device, references can be made to the device structure diagram shown in FIG. 9.

In specific embodiments, the blockchain-based service processing device includes a memory and one or more programs. The one or more programs are stored in the memory. The one or more programs can include one or more modules. Each module can include a series of computer-executable instruction information for the blockchain-based service processing device. One or more processors are configured to execute the one or more programs, including the following computer-executable instruction information: receiving digital identity information corresponding to a target user and risk assessment information that are uploaded by an authorization management platform; creating a first verifiable claim of the risk assessment information corresponding to the digital identity information based on the digital identity information and the risk assessment information, where content data of the first verifiable claim includes the risk assessment information; and returning the content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The devices provided in the embodiments of the present specification can implement all the method steps in the embodiments shown in FIG. 6. Therefore, for specific implementation processes of functions corresponding to the device, references can be made to the embodiments shown in FIG. 6. Details are omitted here for simplicity.

The blockchain-based service processing device provided in the embodiments of the present specification has at least the following beneficial effects: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

Further, based on the methods shown in FIG. 2 to FIGS. 5A-5B, the embodiments of the present specification further provide a storage medium, configured to store computer-executable instruction information. In specific embodiments, the storage medium can be a USB flash drive, an optical disc, a hard disk, etc. The computer-executable instruction information stored in the storage medium can implement the following process when being executed by a processor: obtaining risk assessment information obtained by performing risk assessment on a target user; obtaining digital identity information corresponding to the target user; creating a first verifiable claim of the risk assessment information corresponding to the digital identity information based on the digital identity information and the risk assessment information by using a first blockchain, where content data of the first verifiable claim includes the risk assessment information; and uploading the content data of the first verifiable claim to a second blockchain, obtaining a storage credential of the content data of the first verifiable claim in the second blockchain, and generating a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The computer-executable instruction information stored in the storage medium provided in the embodiments of the present specification can implement all the method steps in the embodiments shown in FIG. 2 to FIGS. 5A-5B when being executed. Therefore, for specific implementation processes of functions corresponding to the computer-executable instruction information stored in the storage medium when the computer-executable instruction information stored in the storage medium is executed, references can be made to the embodiments shown in FIG. 2 to FIGS. 5A-5B. Details are omitted here for simplicity.

The computer-executable instruction information stored in the storage medium provided in the embodiments of the present specification has at least the following beneficial effects when being executed: When obtaining the risk assessment information obtained by performing risk assessment on the target user, an authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

Further, based on the method shown in FIG. 6, the embodiments of the present specification further provide a storage medium, configured to store computer-executable instruction information. In specific embodiments, the storage medium can be a USB flash drive, an optical disc, a hard disk, etc. The computer-executable instruction information stored in the storage medium can implement the following process when being executed by a processor: receiving digital identity information corresponding to a target user and risk assessment information that are uploaded by an authorization management platform; creating a first verifiable claim of the risk assessment information corresponding to the digital identity information based on the digital identity information and the risk assessment information, where content data of the first verifiable claim includes the risk assessment information; and returning the content data of the first verifiable claim to the authorization management platform, so that the authorization management platform uploads the content data of the first verifiable claim to a second blockchain, obtains a storage credential of the content data of the first verifiable claim in the second blockchain, and generates a risk assessment card corresponding to the target user based on the storage credential and the first verifiable claim, where the second blockchain is connected to a service processing platform, and the risk assessment card is used by the service processing platform to obtain the risk assessment information of the target user from the second blockchain.

The computer-executable instruction information stored in the storage medium provided in the embodiments of the present specification can implement all the method steps in the embodiments shown in FIG. 6 when being executed. Therefore, for specific implementation processes of functions corresponding to the computer-executable instruction information stored in the storage medium when the computer-executable instruction information stored in the storage medium is executed, references can be made to the embodiments shown in FIG. 6. Details are omitted here for simplicity.

The computer-executable instruction information stored in the storage medium provided in the embodiments of the present specification has at least the following beneficial effects when being executed: When obtaining the risk assessment information obtained by performing risk assessment on the target user, the authorization management platform creates the first verifiable claim used to claim the risk assessment information based on the digital identity information and the risk assessment information of the target user by cooperating with the first blockchain; and then uploads the content data of the first verifiable claim to the second blockchain for storage, obtains the storage credential of the content data of the first verifiable claim in the second blockchain, and generates the risk assessment card corresponding to the risk assessment information of the target user based on the storage credential and the first verifiable claim. As such, the service processing platform connected to the second blockchain can obtain the risk assessment information from the second blockchain by using the risk assessment card, which is convenient for the service processing platform to obtain the risk assessment information from the second blockchain. In addition, the risk assessment information is stored in the second blockchain, thereby ensuring that the risk assessment information cannot be tampered with, i.e., ensuring security and authenticity of risk assessment data. Furthermore, in the embodiments of the present specification, the service processing platform connected to the second blockchain can be authorized to use the risk assessment card to obtain the risk assessment information of the target user from the second blockchain, so that the service processing platform connected to the second blockchain can share the risk assessment information of the target user. This prevents risk assessment from being performed on the user repeatedly when the user performs risk-related services on different service processing platforms, simplifies a service processing process, improves service processing efficiency, and further improves user experience because risk assessment does not need to be performed on the user repeatedly. In addition, identification information of the first verifiable claim and status information representing whether the content data of the first verifiable claim is valid are maintained in the first blockchain. As such, after the risk assessment information of the user is updated, the first verifiable claim corresponding to the old risk assessment information can be marked as an invalid state, and a first verifiable claim of new risk assessment information can be marked as a valid state, thereby updating the risk assessment information of the user.

Specific embodiments of the present specification are described above. Other embodiments fall within the scope of the appended claims. In some cases, the actions or steps described in the claims can be performed in an order different from the order in the embodiments and the desired results can still be achieved. In addition, the process depicted in the accompanying drawings does not necessarily need the shown particular order or sequence to achieve the desired results. In some implementations, multi-tasking processing and parallel processing are allowed or may be advantageous.

In the 1990s, whether a technical improvement is a hardware improvement (for example, an improvement of circuit structures, such as a diode, a transistor, or a switch) or a software improvement (an improvement of a method process) can be clearly distinguished. However, as technologies develop, current improvements of many method process can be considered as direct improvements of hardware circuit structures. Almost all designers program an improved method process into a hardware circuit, to obtain a corresponding hardware circuit structure. Therefore, a method process can be implemented by using a hardware entity module. For example, a programmable logic device (PLD) (for example, a field programmable gate array (FPGA)) is such an integrated circuit, and a logical function of the PLD is determined by a user through device programming. A designer performs programming to “integrate” a digital system to a single PLD, without needing a chip manufacturer to design and manufacture a dedicated integrated circuit chip. In addition, at present, instead of manually manufacturing an integrated circuit chip, this type of programming is mostly implemented by using “logic compiler (logic compiler)” software. The “logic compiler” software is similar to a software compiler used to develop and write a program. Original code needs to be written in a particular programming language before compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are most commonly used at present. A person skilled in the art should also understand that a hardware circuit that implements a logical method process can be readily obtained provided that the method process is logically programmed by using several of the previously described HDLs and is programmed into an integrated circuit.

A controller can be implemented by using any appropriate method. For example, the controller can be in a form of a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of control logic of the memory. A person skilled in the art should also know that, in addition to implementing the controller by using only the computer readable program code, method steps can be logically programmed to allow the controller to implement the same function in a form of the logic gate, the switch, the ASIC, the programmable logic controller, or the built-in microcontroller. Therefore, the controller can be considered as a hardware component, and an apparatus included in the controller and configured to implement various functions can also be considered as a structure in the hardware component. Alternatively, the apparatus configured to implement various functions can even be considered as both a software module for implementing the method and a structure in the hardware component.

The system, apparatus, module, or unit illustrated in the previously described embodiments can be specifically implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into various units based on functions for separate description. Certainly, when the present application is implemented, functions of the units can be implemented in one or more pieces of software and/or hardware.

A person skilled in the art should understand that the embodiments of the present application can be provided as a method, a system, or a computer program product. Therefore, the present application can use hardware only embodiments, software only embodiments, or embodiments with a combination of software and hardware. In addition, the present application can use a form of a computer program product that is implemented on one or more computer-usable storage media (including but not limited to a magnetic disk memory, a CD-ROM, an optical memory, etc.) that include computer-usable program code.

The present application is described with reference to the flowcharts and/or block diagrams of the method, the device (system), and the computer program product according to the embodiments of the present specification. It should be understood that computer program instruction information can be used to implement each process and/or each block in the flowcharts and/or the block diagrams and a combination of a process and/or a block in the flowcharts and/or the block diagrams. The computer program instruction information can be provided for a general-purpose computer, a dedicated computer, an embedded processor, or a processor of another programmable data processing device to generate a machine, so that the instruction information executed by a computer or a processor of another programmable data processing device generates an apparatus for implementing a specific function in one or more processes in the flowcharts and/or in one or more blocks in the block diagrams.

Alternatively, the computer program instruction information can be stored in a computer readable memory that can instruct a computer or another programmable data processing device to work in a specific way, so that the instruction information stored in the computer readable memory generates a product that includes an instruction information apparatus. The instruction information apparatus implements a specified function in one or more processes in the flowcharts and/or in one or more blocks in the block diagrams.

Alternatively, the computer program instruction information can be loaded to a computer or another programmable data processing device, so that a series of operation steps are performed on the computer or another programmable device, thereby generating computer-implemented processing. Therefore, the instruction information executed on the computer or another programmable device provides steps for implementing a specific function in one or more processes in the flowcharts and/or in one or more blocks in the block diagrams.

In a typical configuration, a computing device includes one or more central processing units (CPUs), input/output interfaces, network interfaces, and memories.

The memory can include a non-persistent memory, a random access memory (RAM), a non-volatile memory, and/or other forms in computer readable media, for example, a read-only memory (ROM) or a flash memory (flash RAM). The memory is an example of the computer readable medium.

The computer-readable medium includes persistent, non-persistent, movable, and unmovable media that can store information by using any method or technology. The information can be computer readable instruction information, a data structure, a program module, or other data. An example of the computer storage medium includes but is not limited to a phase-change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a cassette magnetic disk storage or another magnetic storage device, or any other non-transmission medium. The computer storage medium can be configured to store information that can be accessed by a computing device. As defined in the present application, the computer readable medium does not include computer readable transitory media (transitory media) such as a modulated data signal and a carrier.

It is worthwhile to further note that, the terms “include” and “comprise,” or any other variants thereof are intended to cover a non-exclusive inclusion, so that a process, method, product, or device that includes a list of elements not only includes those elements but also includes other elements not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of the present application can be provided as a method, a system, or a computer program product. Therefore, the present application can use a form of hardware only embodiments, software only embodiments, or embodiments with a combination of software and hardware. In addition, the present application can use a form of a computer program product that is implemented on one or more computer-usable storage media (including but not limited to a magnetic disk memory, a CD-ROM, an optical memory, etc.) that include computer-usable program code.

The present application can be described in the general context of computer-executable instruction information executed by a computer, for example, a program module. Generally, the program module includes a routine, a program, an object, a component, a data structure, etc. for executing a specific task or implementing a specific abstract data type. The present application can also be practiced in distributed computing environments. In the distributed computing environments, tasks are performed by remote processing devices connected through a communications network. In the distributed computing environments, the program module can be located in both local and remote computer storage media including storage devices.

The embodiments of the present specification are described in a progressive way. For same or similar parts of the embodiments, mutual references can be made to the embodiments. Each embodiment focuses on a difference from other embodiments. Particularly, a system embodiment is basically similar to a method embodiment, and therefore is described briefly. For related parts, references can be made to some descriptions in the method embodiment.

The previous descriptions are merely embodiments of the present application, and are not intended to limit the present application. A person skilled in the art can make various modifications and changes to the present application. Any modification, equivalent replacement, improvement, etc. made without departing from the spirit and principle of the present application shall fall within the scope of the claims in the present application.

What is claimed is:

1. A computer-implemented method comprising:
obtaining risk assessment information by performing risk assessment on a user;
obtaining a digital identity of the user;
creating a first verifiable claim based on the digital identity and the risk assessment information by using a first blockchain, wherein the first verifiable claim comprises the risk assessment information;
uploading the first verifiable claim to a second blockchain and obtaining a storage credential of the first verifiable claim in the second blockchain;
generating a risk assessment card corresponding to the user based on the storage credential and the first verifiable claim, wherein the second blockchain is connected to a service processing platform; and
providing access to the service processing platform to obtain the risk assessment information of the user from the second blockchain in response to determining that the risk assessment card is used by the service processing platform.

2. The computer-implemented method according to claim 1, wherein creating the first verifiable claim of the risk assessment information based on the digital identity and the risk assessment information by using the first blockchain comprises:
sending the digital identity and the risk assessment information to the first blockchain; and
receiving identification information of the first verifiable claim and the first verifiable claim from the first blockchain.

3. The computer-implemented method according to claim 1, wherein creating the first verifiable claim of the risk assessment information based on the digital identity and the risk assessment information by using the first blockchain comprises:
creating the first verifiable claim based on the digital identity and the risk assessment information; and
writing identification information of the first verifiable claim to the first blockchain.

4. The computer-implemented method according to claim 1, wherein uploading the first verifiable claim to the second blockchain comprises:
encrypting the first verifiable claim based on a public key corresponding to the digital identity to obtain a first ciphertext corresponding to the first verifiable claim; and
uploading the first ciphertext to the second blockchain.

5. The computer-implemented method according to claim 1, wherein the method further comprises:
obtaining an authorization request sent by the user, wherein the authorization request requests permission for the service processing platform to obtain the risk assessment information of the user; and
creating a second verifiable claim based on the authorization request, wherein the second verifiable claim claims that the service processing platform is granted the permission to obtain the risk assessment information of the user.

6. The computer-implemented method according to claim 5, wherein the method further comprises, after creating the second verifiable claim based on the authorization request:
encrypting the second verifiable claim based on a public key corresponding to the digital identity to generate a second ciphertext corresponding to the second verifiable claim; and
uploading the second ciphertext corresponding to the second verifiable claim to the second blockchain.

7. The computer-implemented method according to claim 1, wherein the first verifiable claim further comprises at least one of the following:
a risk assessment number, the digital identity of the user, a digital identity of a risk assessment platform, and time of generation of the risk assessment information.

8. The computer-implemented method according to claim 1, wherein the first blockchain stores status information representing whether the first verifiable claim is valid, and the status information is set to valid when the first verifiable claim is created.

9. The computer-implemented method according to claim 1, wherein obtaining the digital identity of the user comprises:
searching pre-generated digital identities corresponding to users for the digital identity corresponding to the user.

10. The computer-implemented method according to claim 1, wherein obtaining the digital identity of the user comprises:
creating the digital identity of the user based on identification information corresponding to the user on a risk assessment platform or information about an account logged into by the user during the risk assessment on the risk assessment platform.

11. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
obtaining risk assessment information by performing risk assessment on a user;
obtaining a digital identity of the user;
creating a first verifiable claim based on the digital identity and the risk assessment information by using a first blockchain, wherein the first verifiable claim comprises the risk assessment information;
uploading the first verifiable claim to a second blockchain and obtaining a storage credential of the first verifiable claim in the second blockchain;
generating a risk assessment card corresponding to the user based on the storage credential and the first verifiable claim, wherein the second blockchain is connected to a service processing platform; and
providing access to the service processing platform to obtain the risk assessment information of the user from the second blockchain in response to determining that the risk assessment card is used by the service processing platform.

12. The computer-implemented system according to claim 11, wherein creating the first verifiable claim of the risk assessment information based on the digital identity and the risk assessment information by using the first blockchain comprises:
sending the digital identity and the risk assessment information to the first blockchain; and
receiving identification information of the first verifiable claim and the first verifiable claim from the first blockchain.

13. The computer-implemented system according to claim 11, wherein creating the first verifiable claim of the risk assessment information based on the digital identity and the risk assessment information by using the first blockchain comprises:
creating the first verifiable claim based on the digital identity and the risk assessment information; and
writing identification information of the first verifiable claim to the first blockchain.

14. The computer-implemented system according to claim 11, wherein uploading the first verifiable claim to the second blockchain comprises:
encrypting the first verifiable claim based on a public key corresponding to the digital identity to obtain a first ciphertext corresponding to the first verifiable claim; and
uploading the first ciphertext to the second blockchain.

15. The computer-implemented system according to claim 11, wherein the operations further comprise:
obtaining an authorization request sent by the user, wherein the authorization request requests permission for the service processing platform to obtain the risk assessment information of the user; and
creating a second verifiable claim based on the authorization request, wherein the second verifiable claim claims that the service processing platform is granted the permission to obtain the risk assessment information of the user.

16. The computer-implemented system according to claim 15, wherein the operations further comprise, after creating the second verifiable claim based on the authorization request:
encrypting the second verifiable claim based on a public key corresponding to the digital identity to generate a second ciphertext corresponding to the second verifiable claim; and
uploading the second ciphertext corresponding to the second verifiable claim to the second blockchain.

17. The computer-implemented system according to claim 11, wherein the first verifiable claim further comprises at least one of the following:
a risk assessment number, the digital identity of the user, a digital identity of a risk assessment platform, and time of generation of the risk assessment information.

18. The computer-implemented system according to claim 11, wherein the first blockchain stores status information representing whether the first verifiable claim is valid, and the status information is set to valid when the first verifiable claim is created.

19. The computer-implemented system according to claim 11, wherein obtaining the digital identity of the user comprises:
searching pre-generated digital identities corresponding to users for the digital identity corresponding to the user.

20. A non-transitory, computer-readable medium storing one or more instructions executable by a computer system to perform operations comprising:
obtaining risk assessment information by performing risk assessment on a user;
obtaining a digital identity of the user;
creating a first verifiable claim based on the digital identity and the risk assessment information by using a first blockchain, wherein the first verifiable claim comprises the risk assessment information;
uploading the first verifiable claim to a second blockchain and obtaining a storage credential of the first verifiable claim in the second blockchain; and
generating a risk assessment card corresponding to the user based on the storage credential and the first verifiable claim, wherein the second blockchain is connected to a service processing platform; and
providing access to the service processing platform to obtain the risk assessment information of the user from the second blockchain in response to determining that the risk assessment card is used by the service processing platform.
